(19) United States
(12) Patent Application Publication
(10) Pub. No.: US 2013/0282468 A1
(43) Pub. Date: Oct. 24, 2013

(54) SYSTEMS AND METHODS FOR PROVIDING LOYALTY PROGRAMS VIA A DEBIT CARD OR DEBIT CARD ACCOUNT IDENTIFYING DEVICE

(71) Applicant: BRADLEY MICHAEL, Toronto (CA)

(72) Inventor: BRADLEY MICHAEL, Toronto (CA)

(21) Appl. No.: 13/866,314

(22) Filed: Apr. 19, 2013

Related U.S. Application Data
(63) Continuation-in-part of application No. 13/450,989, filed on Apr. 19, 2012.

(51) Int. Cl. G06Q 30/02

(52) U.S. Cl. CPC G06Q 30/0227
USPC 705/14.28

(57) ABSTRACT

A method and system are provided for linking loyalty programs for merchants and debit card customers. This involves storing, in a database memory, loyalty program identifiers, debit card customer identifiers, for each debit card customer and each loyalty program in which that debit card customer is registered, a loyalty program customer identifier and merchant identifiers; receiving transaction information, which includes debit card holder information, a merchant identifier and purchase information, from a merchant; locating a debit card customer identifier corresponding to the debit card holder identifier; determining the loyalty program identifier for the merchant; and determining if the debit card customer identifier is stored in the database memory in linked relation with a loyalty program customer identifier stored in linked relation to the loyalty program identifier and, if so, determining a loyalty program manager, and transmitting the loyalty program customer identifier and the purchase information to the loyalty program manager.

### FIELD

The described embodiments relate to systems and methods for providing loyalty programs via a debit card. This application is a continuation-in-part of U.S. patent application Ser. No. 13/450,989 filed Apr. 19, 2012. The entirety of U.S. patent application Ser. No. 13/450,989 is hereby incorporated by reference.

### INTRODUCTION

Consumers are frequently offered memberships in loyalty programs sponsored by different retailers and merchants. Loyalty programs can be provided by retailer(s) as to gain a competitive advantage over, or market share from, their competitors. Retailers can provide incentives, such as points, store credits, coupons and/or promotional offers, to loyalty reward program members to encourage members to return as customers. Since membership can be at no cost to consumers, consumers often become members of many different loyalty programs. Retailers, on the other hand, continue to be concerned with minimizing the cost of offering these loyalty programs.

There, thus, is a need for retailers to lower the costs of offering loyalty programs and for consumers to more easily earn loyalty rewards.

### SUMMARY

In accordance with an aspect of an embodiment of the invention, there is provided a method of linking a plurality of loyalty programs for a plurality of merchants and a plurality of debit card customers. The method comprises: a) storing, in a database memory, i) a plurality of loyalty program identifiers identifying the plurality of loyalty programs, wherein each loyalty program identifier uniquely identifies a loyalty program in the plurality of loyalty programs; ii) a plurality of debit card customer identifiers identifying the plurality of debit card customers, wherein each debit card customer identifier uniquely identifies a debit card customer in the plurality of debit card customers; iii) for each debit card customer and for each loyalty program in which that debit card customer is registered, a loyalty program customer identifier identifying that debit card customer for that loyalty program; and iv) a plurality of merchant identifiers identifying the plurality of merchants; wherein, each loyalty program identifier in the plurality of loyalty program identifiers is stored in the database memory in linked relation to at least one merchant identifier in the plurality of merchant identifiers, each debit card customer identifier in the plurality of debit card customer identifiers is stored in the database memory in linked relation to at least one loyalty program customer identifier in the plurality of loyalty program customer identifiers, and each loyalty program customer identifier is stored in the database memory in linked relation to an associated loyalty program identifier; b) at a transaction capture module, receiving transaction information from a merchant in the plurality of merchants, wherein the transaction information comprises debit card holder information derived from a debit card held by a debit card holder, a merchant identifier identifying the merchant and purchase information regarding a purchase from the merchant by the debit card holder, and wherein the debit card holder information comprises a debit card holder identifier; and c) operating a mapping and switching processor, linked to the transaction capture module and to the database memory for electronic communication therewith, to i) locate, in the database memory, a debit card customer identifier corresponding to the debit card holder identifier; ii) determine, from the database memory, the loyalty program identifier for the merchant, wherein the loyalty program identifier is determined by locating the merchant identifier in the plurality of merchant identifiers stored in the database memory and identifying the loyalty program identifier stored in linked relation with the located merchant identifier; and iii) determine if the debit card customer identifier is stored in the database memory in linked relation with a loyalty program customer identifier that is stored in the database memory in linked relation to the loyalty program identifier for the merchant and, if so, determining a loyalty program manager based on the determined loyalty program identifier, and transmitting the loyalty program customer identifier and the purchase information to the loyalty program manager; otherwise, not transmitting the purchase information to the loyalty program manager without approval from the debit card customer corresponding to the debit card customer identifier.

In accordance with an embodiment of the invention, there is provided A method of linking a plurality of loyalty programs for a plurality of merchants and a plurality of debit card customers, the method comprising: a) storing, in a database memory, i) a plurality of loyalty program identifiers identifying the plurality of loyalty programs, wherein each loyalty program identifier uniquely identifies a loyalty program in the plurality of loyalty programs; ii) a plurality of debit card customer identifiers identifying the plurality of debit card customers, wherein each debit card customer identifier uniquely identifies a debit card customer in the plurality of debit card customers; and iii) for each debit card customer and for each loyalty program in which that debit card customer is registered, a loyalty program customer identifier identifying that debit card customer for that loyalty program; wherein, each debit card customer identifier in the plurality of debit card customer identifiers is stored in the database memory in linked relation to at least one loyalty program customer identifier in the plurality of loyalty program customer identifiers, and each loyalty program customer identifier is stored in the database memory in linked relation to an associated loyalty program identifier; b) at a transaction capture module, receiving information, wherein the information comprises debit card holder information derived from a debit card account held by a debit card holder, and wherein the debit card holder information comprises a debit card holder identifier; and c) operating a processor, linked to the transaction capture module and to the database memory for electronic communication therewith, to determine if the debit card holder identifier is stored in the database memory in linked relation with a loyalty program customer identifier that is stored in the database memory.

In accordance with an embodiment of the invention, there is provided a system for linking a plurality of loyalty programs for a plurality of merchants and a plurality of debit card customers. The system comprising: a database memory, for storing i) a plurality of loyalty program identifiers identifying the plurality of loyalty programs, wherein each loyalty program identifier uniquely identifies a loyalty program in the plurality of loyalty programs; ii) a plurality of debit card customer identifiers identifying the plurality of debit card customers, wherein each debit card customer identifier uniquely identifies a debit card customer in the plurality of debit card customers; iii) for each debit card customer and for each loyalty program in which that debit card customer is registered, a loyalty program customer identifier identifying that debit card customer for that loyalty program; and iv) a plurality of merchant identifiers identifying the plurality of merchants; wherein, each loyalty program identifier in the plurality of loyalty program identifiers is stored in the database memory in linked relation to at least one merchant identifier in the plurality of merchant identifiers, each debit card customer identifier in the plurality of debit card customer identifiers is stored in the database memory in linked relation to at least one loyalty program customer identifier in the plurality of loyalty program customer identifiers, and each loyalty program customer identifier is stored in the database memory in linked relation to an associated loyalty program identifier; a transaction capture module configured to receive transaction information from a merchant in the plurality of merchants, wherein the transaction information comprises debit card holder information derived from a debit card held by a debit card holder, a merchant identifier identifying the merchant and purchase information regarding a purchase from the merchant by the debit card holder, and wherein the debit card holder information comprises a debit card holder identifier; a mapping and switching processor, linked to the transaction capture module and to the database memory for electronic communication therewith, the mapping and switching processor being configured to i) locate, in the database memory, a debit card customer identifier corresponding to the debit card holder identifier; ii) determine, from the database memory, the loyalty program identifier for the merchant, wherein the loyalty program identifier is determined by locating the merchant identifier in the plurality of merchant identifiers stored in the database memory and identifying the loyalty program identifier stored in linked relation with the located merchant identifier; and iii) determine if the debit card customer identifier is stored in the database memory in linked relation with a loyalty program customer identifier that is stored in the database memory in linked relation to the loyalty program identifier for the merchant and, if so, determine a loyalty program manager based on the determined loyalty program identifier, and transmitting the loyalty program customer identifier and the purchase information to the loyalty program manager.

In accordance with an embodiment of the invention, there is provided a system for linking a plurality of loyalty programs for a plurality of merchants and a plurality of debit card customers. The system comprising: a database memory, for storing i) a plurality of loyalty program identifiers identifying the plurality of loyalty programs, wherein each loyalty program identifier uniquely identifies a loyalty program in the plurality of loyalty programs; ii) a plurality of debit card customer identifiers identifying the plurality of debit card customers, wherein each debit card customer identifier uniquely identifies a debit card customer in the plurality of debit card customers; and iii) for each debit card customer and for each loyalty program in which that debit card customer is registered, a loyalty program customer identifier identifying that debit card customer for that loyalty program; wherein, each debit card customer identifier in the plurality of debit card customer identifiers is stored in the database memory in linked relation to at least one loyalty program customer identifier in the plurality of loyalty program customer identifiers, and each loyalty program customer identifier is stored in the database memory in linked relation to an associated loyalty program identifier; a transaction capture module configured to receive information, wherein the information comprises debit card holder information derived from a debit card account held by a debit card holder, and wherein the debit card holder information comprises a debit card holder identifier; a processor, linked to the transaction capture module and to the database memory for electronic communication therewith, the processor being configured to determine if the debit card holder identifier is stored in the database memory in linked relation with a loyalty program customer identifier that is stored in the database memory.

### DRAWINGS

A preferred embodiment of the present invention will now be described in detail with reference to the drawings, in which:

FIG. 1 is a block diagram of a debit card loyalty network for providing loyalty programs via a debit card, in accordance with an embodiment of the present disclosure;

FIG. 2 is a block diagram of a system for providing loyalty programs via a debit card, in accordance with an embodiment of the present disclosure;

FIG. 3a is a flowchart diagram illustrating the steps of providing loyalty programs via a debit card or debit card account identifying device, in accordance with an embodiment of the present disclosure;

FIG. 3b is a flowchart diagram illustrating another set of steps of providing loyalty programs via a debit card or debit card account identifying device, in accordance with an embodiment of the present disclosure;

FIG. 4 is a screenshot of an example online banking user interface configured with the customer interface module, in accordance with an embodiment of the present disclosure;

FIG. 5 is a screenshot of an interface for linking a loyalty program account to the debit card account, in accordance with an embodiment of the present disclosure;

FIG. 6 is a screenshot of an interface for accessing loyalty program accounts linked to the debit card account, in accordance with an embodiment of the present disclosure; and

FIG. 7 is a flowchart diagram illustrating steps of linking a debit card account with a loyalty program account, in accordance with an embodiment of the present disclosure.

### DESCRIPTION OF VARIOUS EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein. Where considered appropriate, for simplicity and clarity of illustration, reference numerals may be repeated among the figures to indicate corresponding or analogous elements or steps.

The embodiments of the systems and methods described herein may be implemented in hardware or software, or a combination of both. However, preferably, these embodiments are implemented in computer programs executing on programmable computers each comprising at least one module component which comprises at least one processor (e.g., a microprocessor) and/or memory or storage elements, a data storage system (including volatile and non-volatile memory and/or storage elements), at least one input device, and at least one output device. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

The various embodiments described herein generally relate to methods (and associated systems configured to implement the methods) for providing loyalty programs via a debit card in a debit card loyalty system.

Though these methods and systems are described in terms of using a debit card, in some embodiments the debit card may be replaced by a debit card account identifying device. This debit card account identifying device may be a mobile phone, computer chip, or other device capable of conveying a unique identifier associated with a debit card account, such as, a debit card number or a debit card account number. The debit card may be replaced by a debit card account identifying device in embodiments where a physical card is not essential to completing a financial transaction. On the other hand, the debit card may not be replaced by a debit card account identifying device in embodiments where a physical card is essential, such as, where a merchant does not have the equipment necessary to receive the unique identifier conveyed by the debit card account identifying device; for example, where a merchant only has a payment transaction device capable of reading a swiped debit card. Consequently, where in this description reference is made to debit card(s), and it will be understood that this may include debit card account identifying device(s) such as mobile phones, computer chips, or other devices capable of conveying a unique identifier associated with a debit card account.

Similarly to the debit card, though these methods and systems are described in terms of using a loyalty program card, in some embodiments the loyalty program card may be replaced by a loyalty program account identifying device. This loyalty program account identifying device may be a mobile phone, computer chip, or other device capable of conveying a loyalty program customer identifier uniquely associated with a loyalty program account, such as, a loyalty program customer account number. Consequently, where in this description reference is made to loyalty card(s), it will be understood that this may include loyalty program account identifying device(s).

These methods for providing loyalty programs via a debit card in debit card loyalty system include linking, or associating, loyalty programs to a debit card account of a debit card user or holder (herein referred to as a debit card holder). Each loyalty program can be associated with one or more merchants and also corresponds to a loyalty program operator or manager. Merchants can include retailers and any other business entities. Each debit card holder who is a participant of, or registered with, a loyalty program can also be associated with a loyalty program account for that loyalty program. When the debit card holder registers with the debit card loyalty system, that debit card holder can become a debit card customer with a debit card customer identifier. When that debit card, after it is associated with a loyalty program account for a loyalty program, is used in a payment transaction with a merchant associated with that loyalty program, information identifying the loyalty program account and information associated with the payment transaction can be automatically transmitted to the loyalty program manager of the loyalty program.

Debit cards, or bank cards, can be used to access bank accounts at financial institutions and can also be used to make purchases in payment transactions. By enabling loyalty programs to be associated with debit card accounts, consumers are more likely to use debit cards for making purchases. For merchants, increased use of debit cards in payment transactions offers transactional advantages since receiving payment via debit cards is typically more convenient than with cash and debit cards are associated with lower transaction costs than credit cards. For consumers, the association of loyalty programs with debit cards offers convenience since consumers no longer need to carry physical loyalty program identifications (e.g., plastic cards) in order to indicate their participation, or membership, in the loyalty programs, Instead, by linking a consumer's loyalty program account to the debit card account, that consumer's membership in the loyalty program can be automatically determined when that consumer uses the debit card account at the retailer associated with that loyalty program. Further, as the rewards offered by a loyalty program associated with a merchant are more likely to be redeemed at that merchant (as compared to, say, Air Miles®), the merchant can afford to be more generous with the rewards offered both because the merchant's transaction cost can be lower (due to using a debit card instead of a credit card), and because the costs of the rewards offered by the merchant can be based on the cost of the goods or services offered by the merchant instead of being based on the price the customer would typically pay for those goods or services.

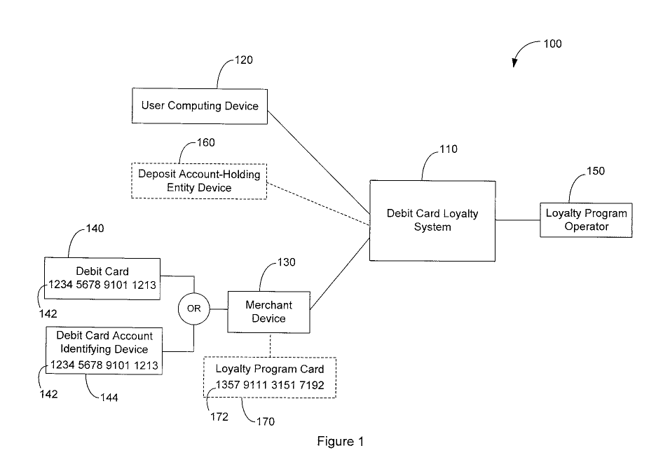

Reference is first made to FIG. 1, which shows a block diagram illustrating a debit card loyalty network 100 for providing loyalty programs via a debit card or debit card account identifying device.

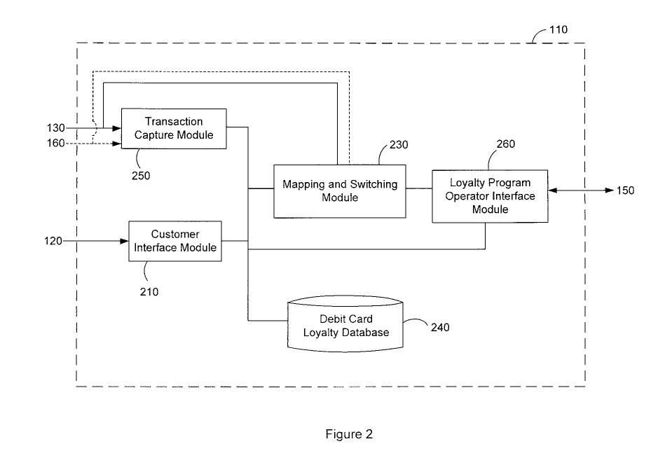

The debit card loyalty network 100 includes a debit card loyalty system 110. The debit card loyalty system 110 is described, below, with reference to FIG. 2. The debit card loyalty network 100 also includes a user computing device 120, a merchant device 130 and a loyalty program operator 150. In some embodiments, the debit card loyalty network 100 may further include a deposit account-holding entity device 160 (as shown in FIG. 1 and as described in more detail below). Each of the user computing device 120, the merchant device 130, the loyalty program operator 150, and the deposit account-holding entity device 160, as may be, are in communication with the debit card loyalty system 110. It will be understood that one or more of each of the user computing devices 120, the merchant device 130, the loyalty program operator 150, and the deposit account-holding entity device can, in some embodiments, be part of the debit card loyalty network 100.

The user computing device 120 may be any device used by any debit card users (e.g., a debit card holder and/or a debit card customer) for interacting with the debit card loyalty system 110. It may, for example, be a personal computer or mobile device equipped with an Internet or network connection that can be used by the debit card user for other purposes, such as online banking. Alternatively, the user computing device 120 may be a kiosk device or station, an automated teller machine (ATM), and any other machine operable for the debit card user to directly or indirectly interact with the debit card loyalty system 110. For example, the debit card user can indirectly interact with the debit card loyalty system 110 through a teller operating his or her computing device at a bank branch. It will be understood that in the embodiments where one or more user computing devices 120 are used as part of the debit card loyalty network 100, the user computing devices 120 may be the same or different types of computing devices.

The merchant device 130 may be any payment transaction device that can retrieve and process account information stored on a payment card, such as a debit card 140. As described above, debit cards 140 may also be referred to as bank cards because they can be used to access bank accounts at financial institutions. The debit cards 140 can also be used to make purchases in payment transactions. Generally, debit cards 140 are identified by a unique identifier 142, such as a debit card number, or any other identifying reference value that identifies the debit card 140. The unique identifier 142 may be referred to herein as a debit card account identifier or a debit card holder identifier. As also described above, in some embodiments the debit card 140 may be replaced by a debit card account identifying device 144, which may be a mobile phone, computer chip, or other device capable of conveying the unique identifier 142 to the merchant device 130. In such embodiments, the merchant device 130 may be any payment transaction device that can retrieve and process account information on a mobile phone, computer chip, or other device capable of conveying a unique identifier 142.

The deposit account-holding entity device 160 may be any device that can transmit transaction information (such as financial transaction information in the case of a purchase transaction, or registration information when linking a debit card account to a loyalty program account, as described below) from the deposit account-holding entity to the debit card loyalty system 110. The deposit account-holding entity device 160 can, for example, be a computer or server equipped with an Internet or network connection that can be used by a deposit account-holding entity, such as a financial institution, to transmit transaction information to the debit card loyalty system 110. The transmitted transaction information can include a transaction identifier, as described in greater detail below. The financial transaction information may include the date, time, payment transaction value, and debit card holder associated with a financial transaction, such as a purchase transaction. The transaction identifier may include the date, time, payment transaction value, or some other comparable identifier or combination of identifiers, as will be described in greater detail below.

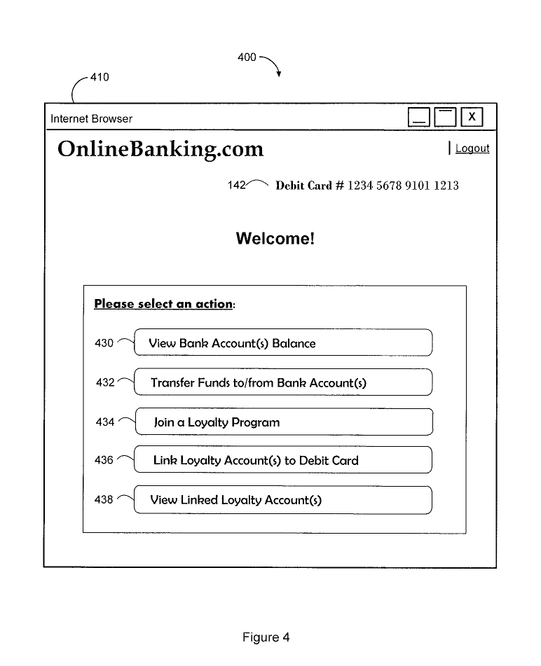

As briefly described above, in order to link a loyalty program account to a debit card account, the debit card holder needs to register or become associated with the debit card loyalty system 110. When the debit card holder becomes associated with the debit card loyalty system 110, that debit card holder becomes a debit card customer of the debit card loyalty system 110 and becomes associated with a debit card customer identifier stored in the debit card loyalty database 240. The debit card holder can become associated with the debit card loyalty system 110 by initializing registration with the debit card loyalty system 110 (as will be described below with reference to FIG. 4) and/or when personal information associated with that debit card holder is provided to the debit card loyalty system 110 by a deposit account-holding entity, such as a financial institution for example. In another embodiment, the debit card holder can become associated with the debit card loyalty system 110 by initializing registration during a payment transaction and/or when personal information associated with that debit card holder is provided to the debit card loyalty system 110 by a merchant, a deposit account-holding entity, and/or a user computing device 120, as will be described in greater detail below. When registration is initialized during a payment transaction, the merchant device 130 can receive a loyalty program account identifier 172, which can be associated with a loyalty program card 170. It will be understood that registration need not be initialized concurrently with the payment transaction and can be initialized before or after the payment transaction in some embodiments.

As briefly described above, a loyalty program may be associated with one or more merchants. Each loyalty program is managed and/or implemented by a corresponding loyalty program operator 150. The merchant can be the loyalty program operator 150. The loyalty program operator 150 receives information or data associated with a payment transaction based on which the loyalty program operator can determine if a reward has been earned. The data received by the loyalty program operator 150 can include an identifier identifying the debit card customer to the loyalty program (referred to herein as a loyalty program customer identifier) and purchase information regarding the purchase made by the debit card customer from the merchant. If a reward has been earned, the loyalty program operator 150 may further compute or determine the value of the reward.

The debit card 140 or debit card identifying device 144 may also be used to redeem a reward or to exercise a promotion or offer provided by the loyalty program. For example, the debit card customer with a debit card account linked with a loyalty program account for the merchant's loyalty program can choose to redeem a reward associated with the loyalty program. The reward could be, for example, a 10% discount off the payment transaction in exchange for 500 points from the loyalty program account.

There are various methods in which the debit card 140 or debit card identifying device 144 can be used to redeem a reward. In one example, the request can be submitted at a point of sale. Using the mapping and switching module 230, the debit card 140 or debit card identifying device 144 can be used to identify the debit card customer and to provide corresponding loyalty program customer information (e.g., the loyalty program customer identifier, loyalty program account balance for that loyalty program customer, etc.) for that debit card customer to the merchant device 130. The merchant device 130 can then enable the debit card customer to select to redeem and apply a reward before proceeding with the payment transaction. Alternatively, the reward could be redeemed as part of the payment transaction, that is, a request to redeem a reward and the transaction information are submitted together. In another example, the reward can be submitted prior to a payment transaction, such as through an interface provided by the customer interface module 210 on a mobile device while in line to pay for a purchase or at home prior to visiting the merchant, and in response, a voucher or redemption code is provided to the debit card customer to redeem the reward at the merchant.

Referring now to FIG. 2, an example embodiment of the debit card loyalty system 110 is shown in a block diagram.

The debit card loyalty system 110 may include a customer interface module 210, a mapping and switching module 230, a debit card loyalty database 240, a transaction capture module 250, and a loyalty program operator interface module 260. The mapping and switching module 230 may include a processor (e.g., a mapping and switching processor) and/or a memory or storage element. As illustrated in FIG. 2, each of the components in the debit card loyalty system 110 may be in communication with any of the other components. Some of these modules may be sub-modules within other of these modules; for example, the transaction capture module 210 may be a sub-module within the mapping and switching module 230.

The debit card loyalty database 240 is an example data storage system and may include one or more databases. For example, the debit card loyalty database 240 can include a database for storing information associated with debit card customers and a database for storing information associated with loyalty programs. Alternatively, information associated with both the debit card customers and loyalty programs can be stored in one database.

To facilitate the linking of a loyalty program account with a debit card account, the debit card loyalty system 110 can store information related to the debit card account and the loyalty program in the debit card loyalty database 240. Other information may be stored in the debit card loyalty database 240 to facilitate other services provided by the debit card loyalty system 110.

Information regarding each loyalty program can be provided from the loyalty program operators 150 and the debit card users via the user computing devices 120. The loyalty program operators 150 can communicate with the debit card loyalty system 110 through the loyalty program operator interface module 260, whereas the user computing devices 120 can communicate with the debit card loyalty system 110 through the customer interface module 210.

Each loyalty program operator 150 can provide information related to their corresponding loyalty program (referred to herein as program description information) to the loyalty program operator interface module 260 to add or register loyalty programs into the debit card loyalty system 110. The loyalty program operator interface module 260 may be configured to provide the program description information directly to the debit card loyalty database 240 for storage and/or to the mapping and switching module 230 for processing. If the mapping and switching module 230 receives the program description information, the mapping and switching module 230 can process the program description information to generate processed program description information and can then store the processed program description information in the debit card loyalty database 240.

A loyalty program can be registered in the debit card loyalty system 110 after the corresponding program description information is stored in the debit card loyalty database 240. For each registered loyalty program, the corresponding program description information that is stored in the debit card loyalty database 240 may include an identifier for a registered loyalty program (referred to herein as a registered loyalty program identifier), a description of the registered loyalty program, identifiers for one or more merchants associated with the registered loyalty program (referred to herein as registered merchant identifiers), information required from a new loyalty program customer to become a member of the loyalty program, a validation protocol for validating a loyalty program account identifier associated with a loyalty program account of the registered loyalty program, information indicating a format preference for how the purchase information is to be received by the loyalty program operator of the registered loyalty program, and other information relevant to the registered loyalty program. One or more loyalty programs may prefer to receive the purchase information in one format, while one or more other loyalty programs may prefer to receive the purchase information in another format. The format preference may define, for example, the order and format in which information, such as the customer identifier, the date and time of the purchase, the identity of the merchant at which the purchase is made, the type of loyalty program membership of the customer, as well as other information, can be transmitted and/or received.

As described above, the user computing devices 120 can also provide information related to the loyalty program to the customer interface module 210, when, for example, a debit card holder is already a member of a loyalty program, and wants to be able to use their debit card to identify themselves to that loyalty program. Additionally, the user computing devices 120 can provide the debit card account information to the customer interface module 210.

The customer interface module 210 can act as a customer user interface for the debit card loyalty system 110 by facilitating communication with the user computing device 120. The customer interface module 210 can receive information associated with the loyalty program and debit card account information from the user computing device 120. The loyalty program information may include an identifier for the loyalty program (herein referred to as a loyalty program identifier) and/or an identifier for a loyalty account (herein referred to as a loyalty program account identifier or a loyalty program customer identifier) for the loyalty program. The debit card account information may include the debit card holder identifier 142. Like the loyalty program operator interface module 260, the customer interface module 210 may provide the loyalty program information and debit card account information received from the user computing device 120 to the mapping and switching module 230, or may instead directly store the loyalty program information and debit card account information in the debit card loyalty database 240.

In some embodiments, the loyalty programs available to be associated with the debit card account may be limited to the loyalty programs registered with the debit card loyalty system 110. In one example configuration, the customer interface module 210 can provide a list of the registered loyalty programs stored in the debit card loyalty database 240 and the debit card customer can only select a loyalty program from that list to be associated with the debit card account. For example, the customer interface module 210 can include a drop down list control consisting of loyalty programs registered in the debit card loyalty system 110, and a debit card customer who wants to associate a loyalty program to his debit card account can only select a loyalty program from the drop down list control. The loyalty program identifiers received from the corresponding user computing device 120 can, thus, be limited to the loyalty programs provided in the drop down list control.

In some embodiments, the customer interface module 210 can be configured through a banking channel, such as an online banking website or an ATM machine, associated with a deposit account-holding entity, such as a financial institution. The financial institution can choose to provide a subset of loyalty programs registered with the debit card loyalty system 110 with which its customers can associate their debit card accounts. This implementation enables financial institutions to establish exclusive relationships with selected loyalty programs that can offer business advantages for both the financial institution and the loyalty program. As well, these exclusive relationships can add substantial value to the financial institution's banking services and may, as a result, attract new customers to its banking services.

Before providing the loyalty program information and debit card account information to the mapping and switching module 230 and/or the debit card loyalty database 240, the customer interface module 210 may process the information received from the user computing device 120. For the purpose of enhancing the security of the debit card accounts, the debit card customer identifier can be a secure token (referred to herein as a secure debit card customer token) derived from information corresponding to the debit card 140 or debit card account identifying device 144 held by the debit card customer. The secure token can be generated using any known cryptographic and/or hashing algorithms that hides or locks the identification information but can nevertheless be decrypted or unlocked with a security protocol to reveal the hidden identification information. Although the secure debit card customer token is different from the debit card number or debit card account number of the debit card 140 (or debit card account identifying device 144, as may be) held by the debit card customer, as long as the correct unlocking security protocol is known, the secure debit card customer token can be decrypted to reveal the debit card information related to the debit card 140 or debit card account identifying device 144 held by the debit card customer. In some embodiments, decryption of secure tokens can occur in a security module in the debit card loyalty system 110.

In some embodiments, the customer interface module 210 may operate to display the account balance of linked loyalty program accounts and/or receive requests related to the linked loyalty program accounts. For example, the customer interface module 210 may operate to display a most recent reward balance for all loyalty program accounts linked to a debit card account, and may further operate to provide options for redeeming rewards from any of the associated loyalty program accounts. In another example, the customer interface module 210 may operate to provide options for removing one or more associated loyalty program accounts from being linked to the debit card account.

In some embodiments, the customer interface module 210 may operate to provide options to enable multiple loyalty program account identifiers corresponding to the same loyalty program to be associated to one debit card account. Optionally, the customer interface module 210 may further operate to provide options for selecting one of the multiple loyalty program account identifiers as a preferred loyalty program account identifier. Some debit card customers may find it advantageous to have multiple loyalty program account identifiers corresponding to one loyalty program associated with one debit card account. For example, a supermarket's loyalty program may offer a promotion that benefits each loyalty account only once. In the case of a couple, for example, one spouse, such as the wife, may be primarily responsible for shopping at that supermarket. It may therefore be beneficial for the wife's debit card account to be associated with both her and her husband's loyalty program accounts in that supermarket's loyalty program. That way, she can benefit from the promotion twice, that is, once with her loyalty program account and again with her husband's loyalty program account when shopping at that supermarket.

Also, the customer interface module 210 may operate to display promotions and/or offers corresponding to loyalty programs. In some embodiments, the promotions and/or offers may vary in accordance with transaction and/or profile information associated with the loyalty program accounts and/or debit card accounts.

The customer interface module 210 may also operate to create a customer profile for each debit card customer. The customer profile can include personal information for that customer (e.g., name, birthdate, contact information, etc.), personal interests, transaction preferences (e.g., frequently visited shops and/or merchants, historical purchases, purchase habits, etc.), and other relevant customer information. This customer profile can be stored in the debit card loyalty database 240 or a database accessible by the customer interface module 210. Optionally, the customer interface module 210 may also be operable by the customer to consent to providing some or all of the personal information included in his or her customer profile to one or more of the loyalty programs to which that customer is linked. If such consent is provided, then this personal information can be provided to one or more of the loyalty programs.

In some embodiments, as will be described with reference to FIGS. 4 to 6, the customer interface module 210 may be provided through an internet or online banking user interface. For example, the customer interface module 210 may be implemented on an existing internet banking web application.

The customer interface module 210 and the loyalty program operator interface module 260 may be configured to offer additional services associated with the debit card loyalty system 110. The customer interface module 210 and the loyalty program operator interface module 260 may be configured to operate individually and/or together to provide these additional services. Optionally, the mapping and switching module 230 may be configured to provide these additional services.

For example, in some embodiments, before the customer interface module 210 transmits the loyalty program information and the debit card account information received from the user computing devices 120, the customer interface module 210 may validate the loyalty program account identifier using validation protocols provided, via the loyalty program operator interface module 260, by the loyalty program operator 150 for the corresponding loyalty program. In this way, the customer interface module 210 can ensure that only valid loyalty program account identifiers are transmitted and/or stored in the debit card loyalty system 110.

In another example, the customer interface module 210 may receive, from user computing devices 120, requests and/or registration information for registering and/or enrolling into loyalty programs.

When the customer interface module 210 receives a request from a user computing device 120 to register a debit card user to a loyalty program, the customer interface module 210 may, in some embodiments, create a loyalty program account for the new loyalty program member and provide or assign a new loyalty program account identifier to that loyalty program account. Alternatively, the customer interface module 210 may forward the request to the loyalty program operator 150 for the loyalty program, via the loyalty program operator interface module 260, for processing and/or approval. The loyalty program operator 150 can then provide or assign a new loyalty program account identifier for the requesting debit card user.

The registration information required to create a loyalty program account for a loyalty program may be predetermined by the loyalty program operator 150 when that loyalty program operator 150 registered the loyalty program in the debit card loyalty system 110. This makes it easier for new customers to sign up with that loyalty program. The registration information can also be retrieved directly from the customer profile created by the customer interface module 210 for that debit card customer, or can be provided from the customer via the customer interface module 210. Alternatively, the registration information can be supplied by both sources, that is, retrieving information from the customer profile created by the customer interface module 210 and from the customer via the customer interface module 210.

Optionally, the customer interface module 210 may also operate to display advertisements and/or marketing information to the debit card customer regarding loyalty programs that the debit card customer can sign up for. Further, optionally, the selection of which loyalty programs to be displayed to the debit card customer can be based on what loyalty programs the debit card customer is currently signed up for (that is, the loyalty programs being advertised to the debit card customer can be selected so that loyalty programs in which the debit card customer is already a member are excluded),

In some embodiments, the advertisements and/or marketing information can include promotions and/or offers associated with the loyalty programs for which the debit card customer is already a member. For example, one of the debit card customer's loyalty programs can advertise that its loyalty program customers are eligible to earn double reward points for any purchases made at any associated merchants each Monday.

After the request to register and/or registration information is received by a loyalty program operator 150, the mapping and switching module 230 may need an approval notification or confirmation from the loyalty program operator 150 before the requesting debit card customer is a registered member of the loyalty program.

As described above, to associate a loyalty program account to a debit card account, the customer interface module 210 may provide the received loyalty program information and the debit card account information to the mapping and switching module 230, or may instead store the received information directly into the debit card loyalty database 240. In the case that the debit card loyalty database 240 receives the loyalty program information and debit card account information from the customer interface module 210, the customer interface module 210 can query the debit card loyalty database 240 to determine if an existing entry corresponds to the received debit card holder identifier 142. If, instead, the debit card loyalty database 240 receives the loyalty program information and debit card account information from the mapping and switching module 230 instead, it is the mapping and switching module 230 that may operate to query the debit card loyalty database 240.

If no entry in the debit card loyalty database 240 corresponds to the debit card holder identifier 142, a debit card customer identifier corresponding to the debit card holder identifier 142 can be stored in a new entry in the debit card loyalty database 240 along with the received loyalty program information. As described above, the loyalty program information received from the user computing device 120 can include the loyalty program identifier and the loyalty program account identifier associated with the loyalty program identifier. The received loyalty program account identifier can then be stored in linked relation in the debit card loyalty database 240 with the debit card customer identifier and the loyalty program identifier.

If a debit card customer identifier in an entry in the debit card loyalty database 240 corresponds to the debit card holder identifier 142, the customer interface module 210 can again query the debit card loyalty database 240 to determine if that debit card customer identifier is linked with a loyalty program account identifier associated with the loyalty program identified by the received loyalty program identifier.

If the debit card customer identifier is not linked with a loyalty program account identifier associated with that loyalty program, the loyalty program account identifier can then be stored in the debit card loyalty database 240 in linked relation with the received loyalty program identifier and the debit card customer identifier.

On the other hand, if the debit card customer identifier is linked with a loyalty program account associated with the received loyalty program identifier, that debit card account is already linked with the loyalty program and the customer interface module 210 may display a message to the user computing device 120 to inform the debit card customer accordingly.

After a loyalty program account of a loyalty program is associated with a debit card account, when that debit card account is used in payment transactions at a merchant associated with the loyalty program, the loyalty program account can automatically earn rewards for that payment transaction.

During the payment transaction, the mapping and switching module 230 may receive transaction data directly from the merchant device 130, the deposit account-holding entity device 160, and/or from the transaction capture module 250. In some embodiments, the transaction information can be received from the merchant device 130 via a deposit account-holding entity (e.g., a financial institution), a deposit account-holding entity directly, a debit card network which may include one or more issuers or issuing banks of debit cards, and/or a processing agent for the merchant that processes payment transactions on behalf of that merchant.

The transaction capture module 250 can operate to retrieve, from the merchant device 130 and/or the deposit account-holding entity device 160, the transaction data associated with the payment transaction. For example, the transaction data can include the purchase information associated with the payment transaction (e.g., a payment transaction value, date, time, etc.), the debit card holder identifier 142, information associated with the products and/or services purchased in the transaction. The product information may include stock-keeping unit (SKU).

As described above, the transaction capture module 250 can operate by routing the transaction data via a payment processing agent for the merchant, a deposit account-holding entity, and/or a debit card network to the mapping and switching module 230, and/or by routing the transaction data directly to the mapping and switching module 230.

Like the customer interface module 210, for the purpose of enhancing security, the transaction capture module 250 may transmit the debit card holder identifier 142 as a secure debit card holder token. The secure debit card holder token can be derived from information corresponding to the debit card 140 or debit card account identifying device 144 held by the debit card holder. Although the secure debit card holder token is different from the debit card number or debit card account number of the debit card 140 (or debit card account identifying device 144, as may be) held by the debit card holder, as long as the correct unlocking security protocol is known, the secure debit card holder token can be decrypted to reveal the debit card information related to the debit card 140 or debit card account identifying device 144 held by the debit card holder. In some embodiments, the debit card holder identifier 142 may correspond with the debit card number or debit card account number. In some other embodiments, the debit card holder identifier 142 may correspond with the secure debit card holder token.

On receipt of the transaction data, the mapping and switching module 230 may operate to process the transaction data.

When the mapping and switching module 230 processes the transaction data received from the merchant device 130 and/or the deposit account-holding entity device 160, the mapping and switching module 230 can retrieve from the transaction data the debit card holder information, a merchant identifier, and the purchase information. The debit card holder information provided from the merchant device 130 and/or the deposit account-holding entity device 160 may include the debit card holder identifier 142. In some embodiments, the mapping and switching module 230 may process the transaction data in real-time (e.g., continuously) or in one or more batches.

The mapping and switching module 230 can identify the loyalty program operator 150 based on the merchant identifier. The mapping and switching module 230 may then configure the purchase information into the preferred format for that loyalty program operator 150 before transmitting the purchase information to the loyalty program operator 150. This can be particularly helpful to program operators 150 since they do not need to further process the purchase information and thus can save on resources and costs. For example, a date can be presented in one format in the purchase information received from the merchant device 130 and/or the deposit account-holding entity device 160 but preferred in a different format by a loyalty program operator 150. A date, such as Nov. 30, 2012, can be presented in the format “2012/11/30” in the purchase information from the merchant, but a loyalty program operator 150 may prefer the date to be presented in the format “Nov. 30, 2012”.

After processing the transaction data, the mapping and switching module 230 can query the debit card loyalty database 240 for an entry containing a debit card customer identifier corresponding to the debit card holder identifier 142 received from the merchant device 130 and/or the deposit account-holding entity device 160.

If the mapping and switching module 230 locates an entry in the debit card loyalty database 240 containing a debit card customer identifier that corresponds to the debit card holder identifier 142, the mapping and switching module 230 can further query the located entry for a loyalty program account identifier for the loyalty program identifier corresponding to the merchant identifier received from the merchant device 130 and/or the deposit account-holding entity device 160.

If the mapping and switching module 230 locates a loyalty program account identifier for the loyalty program from among the loyalty program account identifiers stored in the above located entry, the mapping and switching module 230 can provide the purchase information configured in the preferred format to the loyalty program operator 150 corresponding to that loyalty program. The configured purchase information can include the corresponding loyalty program account identifier. As described above, the loyalty program operator 150 can then determine the points and/or rewards based on the purchase information.

However, if there is no entry in the debit card loyalty database 240 that corresponds to the debit card holder identifier 142 or if an entry in the debit card loyalty database 240 corresponding to the debit card holder identifier 142 is not associated with a loyalty program account identifier for the merchant's loyalty program, the mapping and switching module 230 may coordinate with the customer interface module 210 to notify or indicate to that debit card holder of the existence and/or benefits of the merchant's loyalty program. For example, the mapping and switching module 230 can request for the customer interface module 210 to display or send a message regarding the merchant's loyalty program to that debit card holder (say by email or text message, for example). In some embodiments, the mapping and switching module 230 may nevertheless store the configured purchase information in a database accessible by the customer interface module 210 so that rewards may be retroactively collected if the debit card account identified by the debit card holder identifier 142 later becomes associated with the loyalty program offered by that merchant.

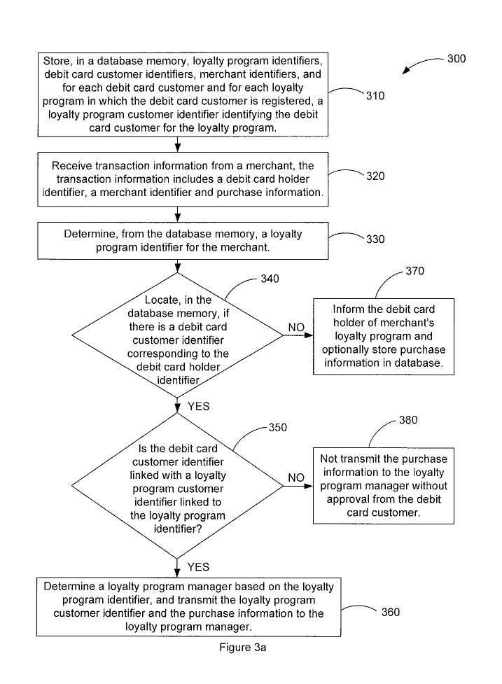

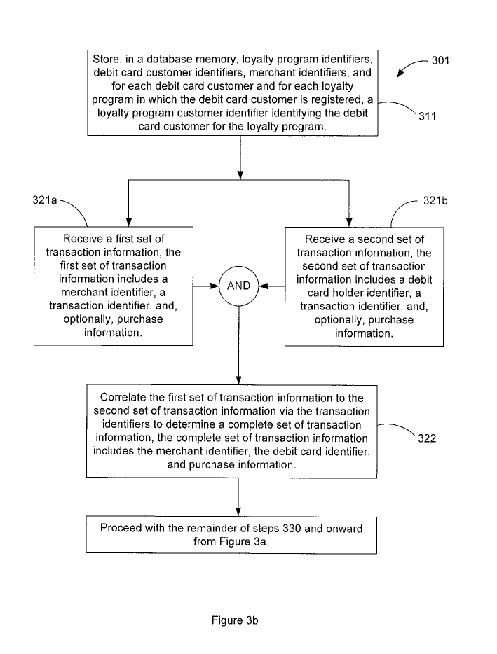

Referring now to FIG. 3a, steps for providing loyalty programs via a debit card or debit card account identifying device are shown in a flowchart diagram.

At step 310, store, in a database memory 240, loyalty program identifiers, debit card customer identifiers, merchant identifiers, and for each debit card customer and for each loyalty program in which the debit card customer is registered, a loyalty program customer identifier identifying the debit card customer for the loyalty program.

The loyalty program identifiers stored in the database memory 240 identify the loyalty programs registered in the debit card loyalty system 110. Each loyalty program identifier uniquely identifies a corresponding loyalty program. The debit card customer identifiers stored in the database memory 240 identify the debit card customers registered in, or whose information is accessible by, the debit card loyalty system 110. Each debit card customer identifier uniquely identifies a corresponding debit card customer. The merchant identifiers stored in the database memory 240 identify the merchants associated with any of the registered loyalty programs.

In the database memory 240, each loyalty program identifier is stored in linked relation to at least one merchant identifier, each debit card customer identifier is stored in linked relation to at least one loyalty program customer identifier, and each loyalty program customer identifier is stored in linked relation to an associated loyalty program identifier.

At step 320, receive transaction information from a merchant, where the transaction information includes debit card information, a merchant identifier and purchase information, and the debit card information can include a debit card holder identifier 142. In some embodiments, this debit card information, including the debit card holder identifier 142 (which may be a debit card number), can be captured from financial transaction data associated with a financial transaction, such as a purchase transaction. This step can occur at the transaction capture module 250.

The debit card holder information can be derived from a debit card 140 or a debit card account identifying device 144 held by a debit card holder, a merchant identifier identifying the merchant and purchase information regarding a purchase from the merchant by the debit card holder.

Steps 330 to 360 can be conducted at the mapping and switching processor 230. As described above, the mapping and switching processor 230 can be linked to the transaction capture module 250 and to the database memory 240 for communication therewith.

At step 330, determine, from the database memory 240, a loyalty program identifier for the merchant.

The loyalty program identifier can be determined by locating the merchant identifier in the database memory 240 and identifying the loyalty program identifier stored in linked relation with the located merchant identifier.

At step 340, determine if there is an entry in the database memory 240 with a debit card customer identifier that corresponds to the debit card holder identifier 142.

If it is determined at step 340 that there is an entry in the database memory 240 with a debit card customer identifier that corresponds to the debit card holder identifier 142, the mapping and switching processor 230 proceeds to perform step 350.

However, if it is determined at step 340 that there is no entry in the database memory 240 with a debit card customer identifier that corresponds to the debit card holder identifier 142, the mapping and switching processor 230 can proceed to perform step 370, which is to inform the debit card holder of the merchant's loyalty program and to optionally store the purchase information in a database accessible by the debit card loyalty system 110 for that debit card holder.

Continuing from step 340, at step 350, determine if the debit card customer identifier is linked with a loyalty program customer identifier linked to the loyalty program identifier.

If it is determined at step 350 that the debit card customer identifier is linked with a loyalty program customer identifier linked to the loyalty program identifier, the mapping and switching processor 230 proceeds to perform step 360, which is to determine a loyalty program manager 150 based on the loyalty program identifier, and to transmit the loyalty program customer identifier and the purchase information to the loyalty program manager 150.

However, if it is determined at step 350 that the debit card customer identifier is not linked with a loyalty program customer identifier linked to the loyalty program identifier, the mapping and switching processor 230 proceeds to perform step 380, which is to not transmit the purchase information to the loyalty program manager 150 without approval from the debit card customer. For example, the purchase information may be stored until approval is received from the debit card customer to join the loyalty program, or, in some embodiments, may simply be discarded without being recorded.

Referring now to FIG. 3b, another set of steps 301 for providing loyalty programs via a debit card or debit card account identifying device are shown in a flowchart diagram.

It some situations it might be impermissible, or impractical, for a merchant to transmit or store some or all of the transaction information associated with a purchase transaction. This can occur where regulations or standards impose constraints on the transmission or storing of certain information, such the debit card number, which are regulated by the Payment Card Industry Data Security Standard (PCI DSS or PCI standards). In these situations, it may be necessary to correlate information from both the merchant (consisting of transaction information, which may include information regarding products purchased by the customer) and the deposit account-holding entity (consisting of transaction data, which may include financial transaction data, such as, a debit card number or debit card account number) to determine a complete set of transaction information. This information may come from the merchant, the deposit account-holding entity, a payment network (such as, a debit card network that may include one or more issuers or issuing banks of debit cards), and/or a processing agent for the merchant or the deposit account-holding entity that processes payment transactions on the merchant's or the deposit account-holding entity's behalf.

Similarly to step 310 of FIG. 3a, at step 311, store, in a database memory 240, loyalty program identifiers, debit card customer identifiers, merchant identifiers, and for each debit card customer and for each loyalty program in which the debit card customer is registered, a loyalty program customer identifier identifying the debit card customer for the loyalty program.

The loyalty program identifiers stored in the database memory 240 identify the loyalty programs registered in the debit card loyalty system 110. Each loyalty program identifier uniquely identifies a corresponding loyalty program. The debit card customer identifiers stored in the database memory 240 identify the debit card customers registered in, or whose information is accessible by, the debit card loyalty system 110. Each debit card customer identifier uniquely identifies a corresponding debit card holder. The merchant identifiers stored in the database memory 240 identify the merchants associated with any of the registered loyalty programs.

In the database memory 240, each loyalty program identifier is stored in linked relation to at least one merchant identifier, each debit card customer identifier is stored in linked relation to at least one loyalty program customer identifier, and each loyalty program customer identifier is stored in linked relation to an associated loyalty program identifier.

At step 321a, receive a first set of transaction information from a merchant, where the first set of transaction information can include a merchant identifier, detailed purchase information, and a transaction identifier. The purchase information can include the date, time, payment transaction value, and/or other information related to the purchase (which may include products purchased and other information required to successfully execute the retailer's loyalty program). The transaction identifier can be an identifier uniquely associated with the transaction. In some embodiments the transaction identifier can be a unique identifier generated and/or assigned during the transaction. In some embodiments, the transaction identifier may be generated by a payment processor included in the merchant device 130, user computing device 120, and/or deposit account-holding entity device 160. In other embodiments, the transaction identifier can be contained within, or derived from, the purchase information, such as a combination of the date, time, payment transaction value (or amount), and location or point-of-sale device of the purchase.

At step 321b, receive a second set of transaction information from a debit card information source, where the second set of transaction information can include debit card information, purchase information, and a transaction identifier. In some embodiments the debit card information source can be a deposit account-holding entity, a payment network (such as, a debit card network that may include one or more issuers or issuing banks of debit cards), a processing agent for the merchant or the deposit account-holding entity that processes payment transactions on the merchant's or the deposit account-holding entity's behalf, and/or a payment processor in the merchant device 130, the deposit account-holding entity device, or the customer interface device 120. The debit card information can include a debit card holder identifier 142. This debit card information, including the debit card holder identifier 142 (which may be a debit card number), can be captured from financial transaction data associated with a financial transaction, such as a purchase transaction. The purchase information can include the date, time, payment transaction value, and the debit card holder identifier 142. The transaction identifier provided in step 321b can be identical to the transaction identifier provided by the merchant in step 321a, or can be a different identifier that can be correlated to the transaction identifier provided by the merchant.

It will be understood that although steps 321a and 321b have been described sequentially, these steps can occur in the opposite order to the description herein or can occur concurrently.

At step 322, correlate the first and second set of transaction information via the transaction identifiers received from the merchant (in step 321a) and the debit card information source (in step 321b) to determine a complete set of transaction information, where the complete set of transaction information includes a debit card holder identifier, a merchant identifier, and purchase information. Correlating the transaction identifiers can include matching the transaction identifier received from the merchant with the transaction identifier received from the debit card information source in order to determine which first set of transaction information corresponds to which second set of transaction information. In some embodiments, correlating the transaction identifiers can include matching the date, time, and/or payment transaction value received from the merchant with the date, time, and/or payment transaction value received from the debit card information source.

It is not necessary that the transaction identifiers received from the merchant and the deposit account-holding entity be identical. In some embodiments, the transaction identifier received from the merchant can be different from the transaction identifier received from the debit card information source. It can still be possible to correlate these differing transaction identifiers where a known relationship exists between the transaction identifiers. This relationship can be a mathematical relationship. In some embodiments, such as where the transaction identifiers include the date and/or time, slight differences in the date and/or time may be permissible, for example, a first set of transaction information and a second set of transaction information may be correlated even though their associated dates and/or times slightly differ. This may be necessary where delays in communications exist between the merchant and the deposit account-holding entity.

Steps 321a, 321b, and 322, can occur at the transaction capture module 250, the mapping and switching module 230, the customer interface module 210, and/or combination of these module or sub-modules within these modules.

Once a complete set of transaction information has been determined in step 322, the remainder of steps 330 onward from FIG. 3a can be carried out using this complete set of transaction information, similar to the manner described above with reference to the transaction information received in step 320.

In some embodiments, the set of steps 301 described above can be useful to retroactively credit a debit card customer for past purchases. In such embodiments, it may be necessary to correlate the first and second sets of transaction information based on the date, time, and payment transaction value, since no other unique transaction identifiers may have been generated and/or assigned during the transaction. Retroactively crediting a debit card customer for previously made purchases can be used as an incentive to attract new debit card holders to join a loyalty program. For example, a loyalty program manager or merchant may offer to retroactively credit a new debit card holder for their past months' purchases in return for associating themselves with a loyalty program. In some embodiments the customer interface module 210 can be used to display the amount of loyalty rewards that a debit card holder would be eligible for if they joined a loyalty program offering retroactive credits as an incentive, this display can occur during step 370 and at a merchant device 130, or a user computing device 120.

Referring now to FIG. 4, a screenshot of an example online banking user interface 400 configured with the customer interface module 210 is shown.

As described above, existing online banking interfaces may be configured to include and implement the customer interface module 210. Generally, the online banking user interface 400 can be accessed from the user computing device 120 through an internet browser 410. A debit card user can login to the online banking user interface 400 using the debit card account identifier 142 and a corresponding password or pass key.

The online banking user interface 400 can provide various banking services. As illustrated in FIG. 4, the online banking user interface 400 can include various controls that may receive input from the debit card user for indicating a banking service they would like to conduct. The controls may be any user input control fields, such as a button and/or a Universal Resource Link (URL). For example, a control 430 that can receive input for redirecting the debit card user to an interface displaying a balance corresponding to one or more bank account(s), a control 432 that can receive input for redirecting the debit card user to an interface for transferring funds, a control 434 that can receive input for enrolling the debit card user into a loyalty program (referred to herein as a loyalty program enrollment control), a control 436 that can receive input for redirecting the debit card account to an interface for linking, or associating, one or more loyalty program accounts to the debit card account (referred to herein as a loyalty link control) and a control 438 for receiving input for redirecting the debit card customer to an interface for accessing linked, or associated, loyalty program accounts (referred to herein as a linked loyalty account control). In this example embodiment, a communication connection with the customer interface module 210 may be activated or initialized when the loyalty program enrollment control 434, the loyalty link control 436 and/or the linked loyalty account control 438 receives an input from the debit card customer.

When a debit card holder links a loyalty account to the debit card, that debit card holder becomes a debit card customer of the debit card loyalty system 110. The debit card holder can then be assigned or provided a corresponding debit card customer identifier. Optionally, before becoming a debit card customer, the debit card holder can be redirected to an interface, such as a membership interface, for receiving registration information before being registered into the debit card loyalty system 110, and being provided a corresponding debit card customer identifier.

As well, from the online banking user interface 400, the debit card holder can be redirected to an interface for registering and/or enrolling into loyalty programs after the loyalty program enrollment control 434 receives an input. As described above, the customer interface module 210 can operate to create a loyalty program account for the new loyalty program member, or alternatively, can forward the registration request to the loyalty program operator 150.

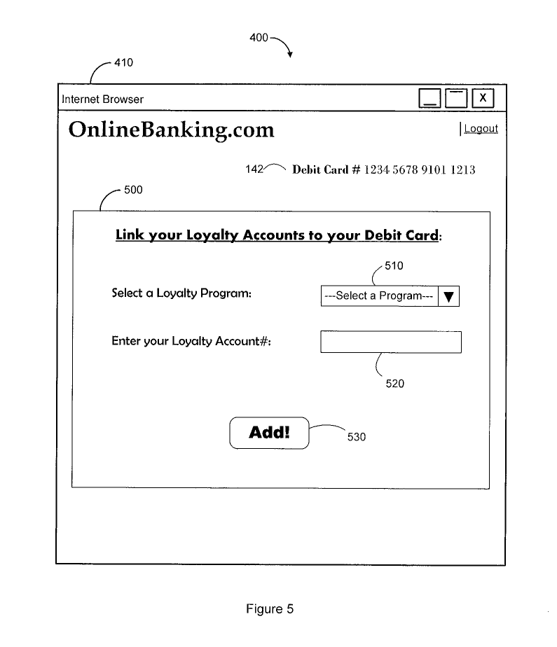

Referring to FIG. 5, and continuing with the above example, a screenshot of an interface 500 for linking a loyalty program account to the debit card account (referred to herein as the loyalty program interface) is shown. The loyalty program interface 500 is an example interface for accessing the customer interface module 210 from the user computing device 120. In this example embodiment, the loyalty program interface 500 can be accessed through the online banking user interface 400 after the loyalty link control 436 (FIG. 4) receives input from the debit card customer.

As illustrated in FIG. 5, the loyalty program interface 500 may be configured by the customer interface module 210 to include one or more controls for receiving information corresponding to a loyalty program account to be associated with the debit card account. For example, a drop down list control 510 for receiving an input selecting a loyalty program (referred to herein as a loyalty program selection control) and a field 520 for receiving input of a loyalty program account identifier (referred to herein as a loyalty account input field) may be provided on the loyalty program interface 500. A control button 530 for receiving input confirming and submitting the values in the loyalty program selection control 510 and the loyalty account input field 520 may also be provided.

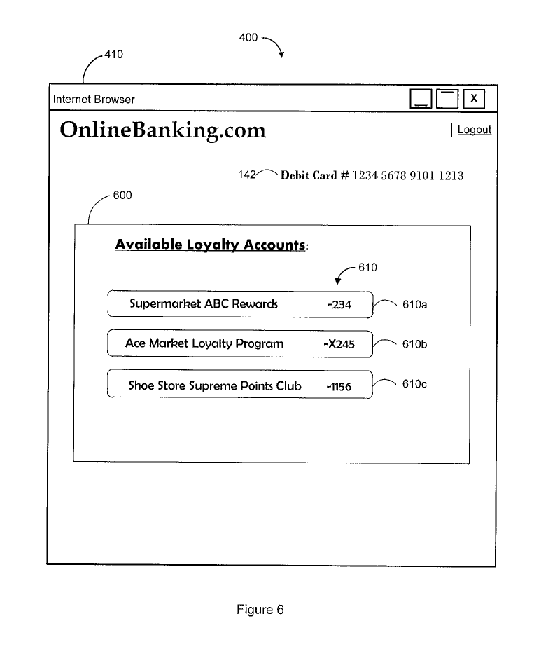

As described above, the customer interface module 210 may further provide an interface for accessing loyalty program accounts linked to the debit card account. Continuing with the above example and with reference to FIG. 6, a screenshot of an interface 600 for accessing loyalty program accounts linked to the debit card account (referred to herein as a linked programs interface). In this example embodiment, the linked programs interface 600 can be accessed through the online banking user interface 400 after the linked loyalty account control 438 (FIG. 4) receives input from the debit card customer.

As illustrated in FIG. 6, a list 610 of linked loyalty program accounts (referred to herein as loyalty account list) may be displayed on the linked programs interface 600. Each loyalty program account 610a, 610b and 610c can be provided on the linked programs interface 600 as a control for receiving input to redirect the debit card customer to further options related to each loyalty program account. The further options related to the loyalty program accounts may include an option to modify settings and preferences associated with the loyalty program account, and an option to display the account balance, for example.

Each of the identifiers described above are uniquely associated with the corresponding entity or information being identified. For example, with reference to FIG. 6, the loyalty program account 610a is associated with a loyalty program identifier corresponding to the Supermarket ABC Rewards loyalty program and a loyalty program account identifier “234”, the loyalty program account 610b is associated with a loyalty program identifier corresponding to the Ace Market Loyalty Program loyalty program and a loyalty program account identifier “X245”, and the loyalty program account 610c is associated with a loyalty program identifier corresponding to the Shoe Store Supreme Points Club loyalty program and a loyalty program account identifier “1156”. Similarly, each merchant has a unique merchant identifier, each debit card customer has a unique debit card customer identifier and each debit card holder has a unique debit card holder identifier.

As described briefly above, in some situations it may be desirable to initialize registration or link a loyalty program account to a debit card account during, or at the point of, a purchase transaction. This can occur when a debit card holder is registered to a loyalty program but is using a separate loyalty program card 170 to earn rewards in that loyalty program. The debit card holder may be willing to associate their debit card account with the loyalty program so that their debit card 140, or debit card account identifying device 144, can be used to earn rewards in the loyalty program without needing the separate loyalty program card 170. This registration or linking may be automatically initialized by the debit card holder using their debit card 140 or debit card account identifying device 144 in the same purchase transaction with their loyal program card 170, as will be described in greater detail below.

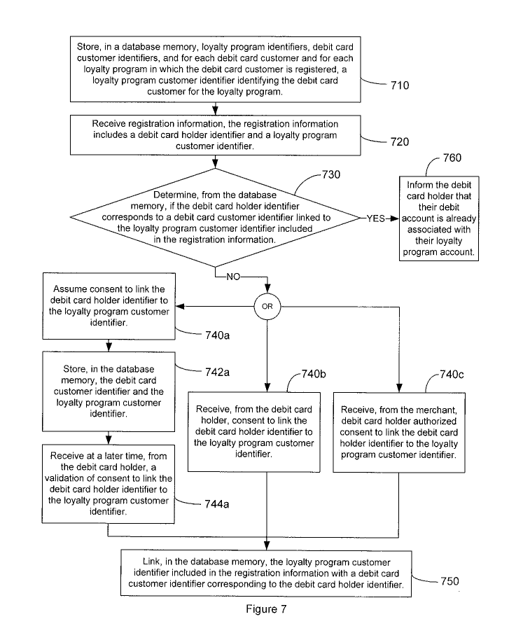

Referring now to FIG. 7, and continuing with the above example, steps 700 for linking a loyalty program account to a debit card account associated with a debit card holder and a debit card or debit card account identifying device are shown in a flowchart diagram.

At step 710, store, in a database memory 240 loyalty program identifiers, debit card customer identifiers, and for each debit card customer and each loyalty program in which the debit card customer is registered, a loyalty program customer identifier identifying the debit card customer for the loyalty program.

The loyalty program identifiers stored in the database memory 240 identify the loyalty programs registered to the debit card loyalty system 110. Each loyalty program identifier uniquely identifies a corresponding loyalty program. The debit card customer identifiers stored in the database memory 240 identify the debit card customers registered in, or whose information is accessible by, the debit card loyalty system 110. Each debit card customer identifier uniquely identifies a corresponding debit card holder.

At step 720, receive registration information from a merchant, a deposit account-holding entity, a payments network or processor, a user computing device, and/or a debit card holder, where the registration information includes a debit card holder identifier 142 and a loyalty program customer identifier 172. The registration information can be received by the debit card loyalty system 110 from the user computer device 120, the merchant device 130, and/or the deposit account-holding entity device 160. Where the merchant device 130 provides the debit card holder identifier 142, the merchant device 130 may derive the debit card holder identifier 142 from a debit card 140 or a debit card account identifying device 144. Where the merchant device 130 provides the loyalty program customer identifier 172, the merchant device may derive the loyalty program customer identifier 172 from a loyalty program card 170 or a loyalty program account identifying device, as described above.

In some embodiments, step 730 may include receiving two sets of information and correlating them to determine a complete set of registration information, similar to that described in steps 321a, 321b, and 322, above. In some embodiments these two sets of information may come from two or more different sources. In some embodiments a first source can be a merchant and a second source can be a debit card information source, where the debit card information source can be similar to the debit card information source described above in step 321b. In some embodiments the sources can include the merchant, the deposit account-holding entity, a payment network (such as, a debit card network that may include one or more issuers or issuing banks of debit cards), a processing agent for the merchant or the deposit account-holding entity that processes payment transactions on the merchant's or the deposit account-holding entity's behalf, and/or a payment processor in the merchant device 130, the deposit account-holding entity device, and/or the customer interface device 120.

For example, in some embodiments, step 730, may include receiving a first set of registration information, where the first set of registration information can include a loyalty program customer identifier, a loyalty program identifier, and a transaction identifier. The transaction identifier can be an identifier uniquely associated with the transaction, including with a corresponding financial transaction. In some embodiments the transaction identifier can be a unique identifier generated and/or assigned during the transaction. In some embodiments, the transaction identifier may be generated by a payment processor included in the merchant device 130, user computing device 120, and/or deposit account-holding entity device 160. In other embodiments, the transaction identifier can be contained within, or derived from, registration information, such as a combination of the date, time, a payment transaction value (or amount) associated with the corresponding financial transaction, and location or point-of-sale device of the purchase.

Continuing the example, step 730, may further include receiving a second set of registration information, where the second set of registration information can include debit card information, and a transaction identifier. The debit card information can include a debit card holder identifier 142 derived from a debit card 140 or debit card account identifying device 144. This debit card information, including the debit card holder identifier 142 (which may be a debit card number), can be captured from financial transaction data associated with a financial transaction, such as a purchase transaction. The transaction identifier provided in the second set of registration information can be identical to the transaction identifier provide in the first set of registration information, or a different identifier that can be correlated to the transaction identifier provided in the first step.

Still continuing with the above example, step 730, can include correlating the first and second set of registration information via the transaction identifiers to determine a complete set of registration information, where the complete set of registration information includes the debit card holder information, the loyalty program customer identifier, and the loyalty program identifier. Correlating the transaction identifiers can include matching the transaction identifier received in the first set of registration information with the transaction identifier received in the second set of registration information in order to determine which first set of registration information corresponds to which second set of registration information. In some embodiments, correlating the transaction identifiers can include matching the dates, times, and/or payment transaction values. It is not necessary that the transaction identifier be identical. In some embodiments the transaction identifiers can be different and a known relationship may exist between the transaction identifiers allowing them to be correlated. This relationship may be a mathematical relationship. In some embodiments, such as where the transaction identifiers include the date and/or time, slight differences in the date and/or time may be permissible, for example, two transaction may be correlated even though their associated dates and/or times slightly differ. This may be necessary where delays in communications exist between the sources of the registration information.

Steps 730 to 750 can be conducted at the mapping and switching module 230, the transaction capture module 250, the customer interface module 210, and/or combination of these devices or sub-modules within these devices, henceforth the “active processor”.

At step 730, determine if there is an entry in the database memory 240 with a debit card customer identifier that corresponds to the debit card holder identifier 142 in linked relation to the loyalty program customer identifier 172.

If it is determined at step 730 that there is an entry in the database memory 240 with a debit card customer identifier that corresponds to the debit card holder identifier 142 and linked to the loyalty program customer identifier 172, the active processor can proceed to perform step 760, which is to inform the debit card holder that their debit card account is already linked to their loyalty program account. This can be done by a display provided at the user computing device 120 or the merchant device 130, or by an email or text message to a mobile device associated with the debit card holder, for example.

However, if it is determined at step 730 that there is no entry in the database memory 240 with a debit card customer identifier that corresponds to the debit card holder identifier 142 and linked to the loyalty program customer identifier 172, the active processor proceeds to step 740a, 740b, or 740c.

Whether the active processor proceeds to step 740a, 740b, or 740c, will depend on how the debit card loyalty system 110 has been configured, as will now be explained.

In order to link a debit card holder identifier 142 (and a respective debit card account) with a loyalty program customer identifier 172 (and a respective loyalty program account), it may be important to receive consent from the debit card holder responsible for that debit card account and loyalty program account. There are many methods for receiving consent: some methods corresponding to some embodiments are described below.

In a first method, the active processor proceeds to step 740a. In this step consent to link the debit card account with the loyalty program account is assumed by virtue of the registration information being received by the debit card loyalty system 110. This can occur when a debit card holder uses both their debit card 140 or debit card account identifying device 144 in the same transaction with their loyalty program card 170 or loyalty program account identifying device. In some embodiments, this transaction may be a financial transaction, such as a purchase transaction. The active processor then proceeds to step 742a, where the active processor stores, in the database memory 240, the debit card holder identifier 142 and the loyalty program account identifier 172.

Where consent is assumed, it can be beneficial to have some additional positive act indicating consent on the part of the debit card holder to validate the consent. A record of validation can protect the merchant or loyalty program manager from debit card holders later alleging that they had not consented to the linking of the debit card account with their loyalty program account.

At step 744a, the debit card loyalty system 110 can receive a validation of consent to link the debit card holder identifier 142 with the loyalty program customer identifier 172. This validation of consent can be provided by the debit card holder through a user computing device 120 at a point in time after the registration information was received by the debit card loyalty system 110. For example, in some embodiments, an automatic email (text message or equivalent communication) may be sent to an email account associated with the debit card holder and contain a hyperlink to allow, or disallow, the linking of their debit card account with their loyalty program account. When the hyperlink allowing the linking of the debit card account to the loyalty program account is clicked, the validation of consent can be sent to the debit card loyalty system 110. In another example embodiment, an online banking user interface, similar to that described above, can include a prompt that automatically notifies the debit card holder of the linking of their debit card account to their loyalty program account when they log into the online banking user interface. This user interface may include buttons to allow or disallow the linking of these accounts, similar to the hyperlinks described in reference to the automatic email, above. After the debit card loyalty system receives the validation of consent, the active processor proceeds to step 750.

In some embodiments, such as where a validation of consent (as described above) is not required, the active processor may proceed directly from step 740a to step 750 without steps 742a and 744a occurring. A validation of consent may not be required where jurisdictional regulations permit an assumption of consent without validation.

In a second method, the active processor proceeds from step 730 to step 740b. In step 740b consent to link the debit card account with the loyalty program account is received by the debit card loyalty system 110 from the debit card holder. This consent may be received with the registration information or shortly thereafter. For example, the debit card holder may be prompted by the merchant device 130 to provide consent during a financial transaction, such as purchase transaction, in which case the debit card holder's consent may be received via the merchant device 130. In some embodiments, this prompt may occur before or after a purchase transaction. Alternatively, the debit card holder may be prompted at a user computer device 120, such as a mobile phone, to provide consent to link their debit card account and loyalty program account. In some embodiments, the prompt to the computer device 120 may occur during, before, or after a purchase transaction. The prompt can be in the form of an automated text message to the user computer device 120 requesting the debit card holder click on a hyperlink or button to provide the consent. After the debit card loyalty system receives the consent, the active processor proceeds to step 750.

In a third method, the active processor proceeds from step 730 to step 740c. In step 740c consent to link the debit card account with the loyalty program account is received by the debit card loyalty system 110 from the merchant. In some embodiments, this consent may be received via the merchant device 130. Unlike with the assumed consent method described above in step 740a, with step 740c the merchant has been given explicit authorization by the debit card holder to provide consent to the debit card loyalty system 110. In some embodiments, this explicit authorization may be given during a financial transaction, such as a purchase transaction. For example, the merchant may have asked the debit card holder if they would like to associate their debit card account with the loyalty program account and received an affirmative response. In some embodiments, the merchant may scan a SKU upon receiving the debit card holder's authorization to provide consent to the debit card loyalty system 110. This SKU can be associated specifically with receiving consent and recorded by the merchant accordingly. Associating a SKU with consent may be convenient or desirable from the perspective of a merchant, as it may not require the merchant to alter their existing Point-of-Sale (POS) system in any significant way. This may avoid operational barriers with implementing the debit card loyalty system 110 described herein. Merchants frequently add new SKUs to their POS system, such as when adding a new product to their inventory. Consequently, adding a SKU associated with consent to a merchant's POS system may be considered an insignificant alteration to that POS system. In some embodiments, scanning this SKU may add a line item to the debit card holder's receipt for a purchase transaction indicating that consent has been provided to link their debit card account to their loyalty program account—this may constitute a written record of consent and a copy of the receipt may be kept by the merchant as well as the debit card holder. After the debit card loyalty system receives the consent, the active processor proceeds to step 750.

At step 750, the active processor stores, in the database memory 240, the debit card holder identifier 142 and the loyalty program customer identifier 172 in a linked relationship. Storing the debit card holder identifier 142 and the loyalty program customer identifier 172 in a linked relationship can include the debit card holder becoming a debit card customer of the debit card loyalty system 110 and being associated with a debit card customer identifier stored in the database memory 240, as described above for linking a loyalty program account to a debit card account. In some embodiments, this debit card customer identifier may be an existing debit card customer identifier in the database memory 240 previously associated with the debit card holder. In other embodiments, this debit card customer identifier may be a new debit card customer identifier stored in the database memory 240. In some embodiments, storing the debit card holder identifier 142 and the loyalty program customer identifier 172 in linked relationship in the database memory may further include storing, in the database memory, the debit card holder identifier 142 and a debit card customer identifier in linked relation and also storing, in the database memory, the loyalty program customer identifier 172 and the loyalty program identifier in linked relation to each other and that debit card customer identifier.

The present invention has been described here by way of example only. Various modification and variations may be made to these exemplary embodiments without departing from the spirit and scope of the invention, which is limited only by the appended claims. For example, in the various user interfaces illustrated in the figures, it will be understood that the illustrated user interface text, fields and controls are provided as examples only and are not meant to be limiting. Other suitable user interface elements may be possible.

1. A method of linking a plurality of loyalty programs for a plurality of merchants and a plurality of debit card customers, the method comprising:
a) storing, in a database memory,
i) a plurality of loyalty program identifiers identifying the plurality of loyalty programs, wherein each loyalty program identifier uniquely identifies a loyalty program in the plurality of loyalty programs;
ii) a plurality of debit card customer identifiers identifying the plurality of debit card customers, wherein each debit card customer identifier uniquely identifies a debit card customer in the plurality of debit card customers; and
iii) for each debit card customer and for each loyalty program in which that debit card customer is registered, a loyalty program customer identifier identifying that debit card customer for that loyalty program;
wherein,
each debit card customer identifier in the plurality of debit card customer identifiers is stored in the database memory in linked relation to at least one loyalty program customer identifier in the plurality of loyalty program customer identifiers, and
each loyalty program customer identifier is stored in the database memory in linked relation to an associated loyalty program identifier;
b) at a transaction capture module, receiving information,
wherein the information comprises debit card holder information derived from a debit card account held by a debit card holder, and
wherein the debit card holder information comprises a debit card holder identifier; and
c) operating a processor, linked to the transaction capture module and to the database memory for electronic communication therewith, to
determine if the debit card holder identifier is stored in the database memory in linked relation with a loyalty program customer identifier that is stored in the database memory.

2. The method as defined in claim 1, the method further comprising:
storing, in the database memory, a plurality of merchant identifiers identifying the plurality of merchants, wherein each loyalty program identifier in the plurality of loyalty program identifiers is stored in the database memory in linked relation to at least one merchant identifier in the plurality of merchant identifiers; and
wherein receiving the information comprises receiving transaction information from a merchant in the plurality or merchants,
wherein the transaction information comprises a merchant identifier identifying the merchant and purchase information regarding a purchase from the merchant by the debit card holder, and
wherein the debit card holder information derived from a debit card account held by a debit card holder is derived from a debit card account identifying device associated with the debit card account; and
wherein the processor comprises a mapping and switching processor, and operating the processor further comprises operating the processor to
i) locate, in the database memory, a debit card customer identifier corresponding to the debit card holder identifier, and
ii) determine, from the database memory, the loyalty program identifier for the merchant, wherein the loyalty program identifier is determined by locating the merchant identifier in the plurality of merchant identifiers stored in the database memory and identifying the loyalty program identifier stored in linked relation with the located merchant identifier, and
wherein determining if the debit card holder identifier is stored in the database memory in linked relation comprises determining if the debit card customer identifier is stored in the database memory in linked relation with a loyalty program customer identifier that is stored in the database memory in linked relation to the loyalty program identifier for the merchant and,
if so, determining a loyalty program manager based on the determined loyalty program identifier, and transmitting the loyalty program customer identifier and the purchase information to the loyalty program manager,
otherwise, not transmitting the purchase information to the loyalty program manager without approval from the debit card customer corresponding to the debit card customer identifier.

3. The method as defined in claim 2, wherein the debit card account identifying device is at least one of a mobile phone, a computer chip, and a device capable of conveying a unique identifier.

4. The method as defined in claim 3, wherein the unique identifier is at least one of a debit card number, a debit card account number, the debit card holder identifier, and the debit card customer identifier.

5. The method as defined in claim 1, the method further comprising:
storing, in the database memory, a plurality of merchant identifiers identifying the plurality of merchants, wherein each loyalty program identifier in the plurality of loyalty program identifiers is stored in the database memory in linked relation to at least one merchant identifier in the plurality of merchant identifiers; and
wherein receiving the information comprises receiving a first set of transaction information from a merchant in the plurality of merchants and a second set of transaction information from a debit card information source,
wherein the first set of transaction information comprises a merchant identifier identifying the merchant and a first transaction identifier,
wherein the second set of transaction information comprises the debit card holder information derived from a debit card account held by a debit card holder and a second transaction identifier,
wherein at least one of the first set of transaction information and the second set of transaction information comprises purchase information regarding a purchase from the merchant by the debit card holder, and
wherein the debit card holder information derived from a debit card account held by a debit card holder is derived from a debit card or a debit card account identifying device associated with the debit card account; and
wherein the processor comprises a mapping and switching processor, and operating the processor further comprises operating the processor to
i) correlate the first set of transaction information to the second set of transaction information using the first and second transaction identifiers, to determine a full set of transaction information, wherein the full set of transaction information comprises the merchant identifier, the debit card holder information, and the purchase information,
ii) locate, in the database memory, a debit card customer identifier corresponding to the debit card holder identifier, and
iii) determine, from the database memory, the loyalty program identifier for the merchant, wherein the loyalty program identifier is determined by locating the merchant identifier in the plurality of merchant identifiers stored in the database memory and identifying the loyalty program identifier stored in linked relation with the located merchant identifier, and
wherein determining if the debit card holder identifier is stored in the database memory in linked relation comprises determining if the debit card customer identifier is stored in the database memory in linked relation with a loyalty program customer identifier that is stored in the database memory in linked relation to the loyalty program identifier for the merchant and,
if so, determining a loyalty program manager based on the determined loyalty program identifier, and transmitting the loyalty program customer identifier and the purchase information to the loyalty program manager;
otherwise, not transmitting the purchase information to the loyalty program manager without approval from the debit card customer corresponding to the debit card customer identifier.

6. The method as defined in claim 5, wherein the first and second transaction identifier are substantially identical and correlating the first set of transaction information to the second set of transaction information using the first and second transaction identifiers comprises matching the first and second transaction identifiers.

7. The method as defined in claim 5, wherein the first and second transaction identifiers are not substantially identical and correlating the first set of transaction information to the second set of transaction information using the first and second transaction identifier comprises using a known relationship to correlate the first and second transaction identifiers.

8. The method as defined in claim 5, wherein the first and second transaction identifiers comprise at least one of:
a date;
a time;
a payment transaction value;
a unique identifier generated or assigned during a transaction; and
at least a part of the purchase information.

9. The method as defined in claim 1, wherein:
receiving the information comprises receiving registration information,
wherein the registration information comprises the debit card holder information derived from a debit card account, a loyalty program customer identifier, and a loyalty program identifier, and
wherein the debit card holder information derived from a debit card account held by a debit card holder is derived from a debit card or debit card account identifying device associated with the debit card account; and
wherein the processor comprises an active processor, and operating the processor comprises operating the active processor, and
wherein determining if the debit card holder identifier is stored in the database memory in linked relation comprises determining if the debit card holder identifier is stored in the database memory in linked relation to a debit card customer identifier stored in linked relation to the loyalty program customer identifier stored in linked relation to the loyalty program identifier and,
if not, storing, in the database memory, the debit card holder identifier in linked relation to a debit card customer identifier and storing, in the database memory, the loyalty program customer identifier and the loyalty program identifier in linked relation to each other and that debit card customer identifier.

10. The method as defined in claim 9, wherein:
receiving the registration information comprises receiving a first set of registration information from a merchant in the plurality of merchants and a second set of registration information from a debit card information source,
wherein the first set of registration information comprises the loyalty program customer identifier, the loyalty program identifier, and a first transaction identifier,
wherein the second set of registration information comprises the debit card holder information derived from a debit card account held by a debit card holder and a second transaction identifier; and
wherein operating the active processor further comprises operating the active processor to
i) correlate the first set of registration information to the second set of registration information using the first and second transaction identifiers, to determine a full set of registration information, wherein the full set of registration information comprises the debit card holder identifier, the loyalty program customer identifier, and the loyalty program identifier.

11. A system for linking a plurality of loyalty programs for a plurality of merchants and a plurality of debit card customers, the system comprising:
a database memory, for storing
i) a plurality of loyalty program identifiers identifying the plurality of loyalty programs, wherein each loyalty program identifier uniquely identifies a loyalty program in the plurality of loyalty programs;
ii) a plurality of debit card customer identifiers identifying the plurality of debit card customers, wherein each debit card customer identifier uniquely identifies a debit card customer in the plurality of debit card customers; and
iii) for each debit card customer and for each loyalty program in which that debit card customer is registered, a loyalty program customer identifier identifying that debit card customer for that loyalty program;
wherein,
each debit card customer identifier in the plurality of debit card customer identifiers is stored in the database memory in linked relation to at least one loyalty program customer identifier in the plurality of loyalty program customer identifiers, and
each loyalty program customer identifier is stored in the database memory in linked relation to an associated loyalty program identifier;
a transaction capture module configured to receive information,
wherein the information comprises debit card holder information derived from a debit card account held by a debit card holder, and
wherein the debit card holder information comprises a debit card holder identifier;
a processor, linked to the transaction capture module and to the database memory for electronic communication therewith, the processor being configured to
determine if the debit card holder identifier is stored in the database memory in linked relation with a loyalty program customer identifier that is stored in the database memory.

12. The system as defined in claim 11, the system further comprising:
a database memory, for storing a plurality of merchant identifiers identifying the plurality of merchants, wherein each loyalty program identifier in the plurality of loyalty program identifiers is stored in the database memory in linked relation to at least one merchant identifier in the plurality of merchant identifiers; and
wherein the transaction capture module being configured to receive the information comprises the transaction capture module being configure to receive transaction information from a merchant in the plurality or merchants,
wherein the transaction information comprises a merchant identifier identifying the merchant and purchase information regarding a purchase from the merchant by the debit card holder, and
wherein the debit card holder information derived from a debit card account held by a debit card holder is derived from a debit card account identifying device associated with the debit card account; and
wherein the processor comprises a mapping and switching processor, the processor being further configured to
i) locate, in the database memory, a debit card customer identifier corresponding to the debit card holder identifier, and
ii) determine, from the database memory, the loyalty program identifier for the merchant, wherein the loyalty program identifier is determined by locating the merchant identifier in the plurality of merchant identifiers stored in the database memory and identifying the loyalty program identifier stored in linked relation with the located merchant identifier, and
wherein determining if the debit card holder identifier is stored in the database memory in linked relation comprises determining if the debit card customer identifier is stored in the database memory in linked relation with a loyalty program customer identifier that is stored in the database memory in linked relation to the loyalty program identifier for the merchant and, if so, determining a loyalty program manager based on the determined loyalty program identifier, and transmitting the loyalty program customer identifier and the purchase information to the loyalty program manager.

13. The system as defined in claim 12, wherein the debit card account identifying device is at least one of a mobile phone, a computer chip, and a device capable of conveying a unique identifier.

14. The system as defined in claim 13, wherein the unique identifier is at least one of a debit card number, a debit card account number, the debit card holder identifier, and the debit card customer identifier.

15. The system as defined in claim 11, the system further comprising:
a database memory, for storing a plurality of merchant identifiers identifying the plurality of merchants, wherein each loyalty program identifier in the plurality of loyalty program identifiers is stored in the database memory in linked relation to at least one merchant identifier in the plurality of merchant identifiers; and
wherein the transaction capture module being configured to receive the information comprises the transaction capture module being configure to receive a first set of transaction information from a merchant in the plurality or merchants and a second set of transaction information from a debit card information source,
wherein the first set of transaction information comprises a merchant identifier identifying the merchant and a first transaction identifier,
wherein the second set of transaction information comprises the debit card holder information derived from a debit card account held by a debit card holder and a second transaction identifier,
wherein at least one of the first set of transaction information and the second set of transaction information comprises purchase information regarding a purchase from the merchant by the debit card holder, and
wherein the debit card holder information derived from a debit card account held by a debit card holder is derived from a debit card or a debit card account identifying device associated with the debit card account; and
wherein the processor comprises a mapping and switching processor, the processor being further configured to
i) correlate the first set of transaction information to the second set of transaction information using the first and second transaction identifiers, to determine a full set of transaction information, wherein the full set of transaction information comprises the merchant identifier, the debit card holder information, and the purchase information,
ii) locate, in the database memory, a debit card customer identifier corresponding to the debit card holder identifier, and
iii) determine, from the database memory, the loyalty program identifier for the merchant, wherein the loyalty program identifier is determined by locating the merchant identifier in the plurality of merchant identifiers stored in the database memory and identifying the loyalty program identifier stored in linked relation with the located merchant identifier, and
wherein determining if the debit card holder identifier is stored in the database memory in linked relation comprises determining if the debit card customer identifier is stored in the database memory in linked relation with a loyalty program customer identifier that is stored in the database memory in linked relation to the loyalty program identifier for the merchant and, if so, determine a loyalty program manager based on the determined loyalty program identifier, and transmitting the loyalty program customer identifier and the purchase information to the loyalty program manager.

16. The system as defined in claim 15, wherein the first and second transaction identifier are substantially identical and correlating the first set of transaction information to the second set of transaction information using the first and second transaction identifiers comprises matching the first and second transaction identifiers.

17. The system as defined in claim 15, wherein the first and second transaction identifiers are not substantially identical and correlating the first set of transaction information to the second set of transaction information using the first and second transaction identifier comprises using a known relationship to correlate the first and second transaction identifiers.

18. The system as defined in claim 15, wherein the first and second transaction identifiers comprise at least one of:
a date;
a time;
a payment transaction value;
a unique identifier generated or assigned during a transaction; and
at least a part of the purchase information.

19. The system as defined in claim 11, wherein:
wherein the transaction capture module being configured to receive the information comprises the transaction capture module being configured to receive registration information,
wherein the registration information comprises the debit card holder information derived from a debit card account, a loyalty program customer identifier, and a loyalty program identifier, and
wherein the debit card holder information derived from a debit card account held by a debit card holder is derived from a debit card or debit card account identifying device associated with the debit card account; and
wherein the processor comprises an active processor, and
wherein determining if the debit card holder identifier is stored in the database memory in linked relation comprises determining if the debit card holder identifier is stored in the database memory in linked relation to a debit card customer identifier stored in linked relation to the loyalty program customer identifier stored in linked relation to the loyalty program identifier and, if not, storing, in the database memory, the debit card holder identifier in linked relation to a debit card customer identifier and storing, in the database memory, the loyalty program customer identifier and the loyalty program identifier in linked relation to each other and that debit card customer identifier.

20. The system as defined in claim 19, wherein:
wherein the transaction capture module being configured to receive the registration information comprises the transaction module being configured to receive a first set of registration information from a merchant in the plurality of merchants and a second set of registration information from a debit card information source,
wherein the first set of registration information comprises the loyalty program customer identifier, the loyalty program identifier, and a first transaction identifier,
wherein the second set of registration information comprises the debit card holder information derived from a debit card account held by a debit card holder and a second transaction identifier; and
the processor being further configured to
i) correlate the first set of registration information to the second set of registration information using the first and second transaction identifiers, to determine a full set of registration information, wherein the full set of registration information comprises the debit card holder identifier, the loyalty program customer identifier, and the loyalty program identifier.
